(19) United States
(12) Patent Application Publication
(10) Pub. No.: US 2021/0000105 A1
(43) Pub. Date: Jan. 7, 2021

(54) NANOSILVER PARTICLE, POROUS MATERIAL COMPOSITE, AND METHOD OF PRODUCING THE SAME

(71) Applicant: GENE'E TECH CO., LTD., New Taipei City (TW)

(72) Inventors: Chung-Hao WANG, Taipei City (TW); Shu-Jyuan YANG, Taipei City (TW); Chien-Ming LEE, Taipei City (TW)

(21) Appl. No.: 16/459,856

(22) Filed: Jul. 2, 2019

(51) Int. Cl. A01N 25/08; A01N 59/16; A01N 59/00; B22F 9/24; B22F 1/00

(52) U.S. Cl. CPC A01N 25/08; A01N 59/16; B22F 2301/255; B22F 9/24; B22F 1/0018; A01N 59/00

(57) ABSTRACT

Nanosilver particles, a porous material composite containing same, and a method of producing same are introduced. The method includes the steps of (a) mixing silver salts-containing precursor and protecting agent to form a first liquid mixture; (b) introducing organic reductant into a first reactant to form a second reactant, wherein the silver salts-containing precursor is reduced by the organic reductant to form nanosilver particles; introducing organic reductant into the first liquid mixture to form a second liquid mixture, wherein the silver salts-containing precursor is reduced by the organic reductant to form nanosilver particles; and (c) introducing alkalinizing agent into the nanosilver particles-containing second liquid mixture. The porous material composite includes a porous material and nanosilver particles attached to outer and inner surfaces of the porous material. The nanosilver particles and the porous material composite including same protect users against harm otherwise caused by products containing conventional nanosilver particles.

### BACKGROUND OF THE INVENTION

### 1. Field of the Invention

The present disclosure relates to nanosilver particles, porous material composites comprising the nanosilver particles, and methods of producing the same, and in particular to nanosilver particles capable of bacteriostasis.

### 2. Description of the Related Art

Metal, such as gold (Au), silver (Ag), mercury (Hg), lead (Pb), nickel (Ni), copper (Cu), and zinc (Zn), is a common antimicrobial material. However, mercury and lead are harmful to the human body, copper ends up with verdigris as a result of oxidation. Unfortunately, verdigris is toxic. The bacteriostasis of zinc is little. In consequence, the aforesaid metallic materials are disadvantaged by limited scope of application. Being pricey, gold is seldom cost-effective when put into use. Considering the limited scope of application of the aforesaid metallic materials, silver is the metallic antimicrobial material that has the broadest scope of application.

Recent research suggests that the activity of nanoscale silver particles is enhanced by an increase in the surface area thereof, as their small particle diameter renders their surface area large. So, if the surface area of silver particles is increased, the activity of the silver particles will be enhanced, thereby releasing activated silver ions readily. The SH group of bacterial apoenzyme is attracted and thereby bonded to the activated silver ions, and thus the SH-containing apoenzyme is deactivated, leading to the demise of the bacteria. Furthermore, bacteria carrying negative charges come into contact with silver ions carrying positive charges and thereby are attracted thereto, and in consequence the silver ions break the cellular wall of the bacteria and intrude into the bacteria to interfere with their cellular physiological functions. As a result, metabolism and reproduction of the bacteria ceases, killing the bacteria. Afterward, the silver ions are released from the broken cellular walls of the killed bacteria to continue with their mission. Therefore, nanosilver particles are antimicrobial, bactericidal, and effective in inhibiting bacterial growth.

### BRIEF SUMMARY OF THE INVENTION

Conventional nanosilver particles are usually produced by chemical synthesis, using chemical reductants. The chemical reductants not only pollute the environment but also linger on nanosilver particles. When nanosilver particles produced by chemical synthesis are applied to a bactericidal product or bacteriostatic product which may come into contact with the human body, the lingering chemical reductants may also come into contact with the human body; as a result, products which contain conventional nanosilver particles are harmful to the human body.

An objective of the present disclosure is to address the aforesaid issue by providing a method of producing nanosilver particles, comprising the steps of: (a) mixing silver salts-containing precursor and protecting agent to form a first liquid mixture, wherein the protecting agent stabilizes particle diameter and structure of nanosilver particles formed from the silver salts-containing precursor; (b) introducing organic reductant into the first liquid mixture to form a second liquid mixture, wherein the silver salts-containing precursor is reduced by the organic reductant to form nanosilver particles; and (c) introducing alkalinizing agent into the nanosilver particles-containing second liquid mixture.

Regarding the method, wherein the second liquid mixture has a pH of 8-12.

Regarding the method, wherein the silver salts-containing precursor is one selected from the group consisting of silver nitrate, silver chloride, silver oxalate, and silver acetate.

Regarding the method, wherein the organic reductant is one selected from the group consisting of glucose, sucrose, maltose, starch, catechin, ascorbic acid and gallic acid.

Regarding the method, wherein the organic reductant is of a concentration of 2˜15 mM.

In order to achieve at least the above objective, the present disclosure provides nanosilver particles produced by the method.

In order to achieve at least the above objective, the present disclosure provides a porous material composite, comprising: a porous material; and nanosilver particles attached to an outer surface and an inner surface of the porous material, wherein a ratio of an attachment area of the outer and inner surfaces which the nanosilver particles are attached to a surface area of the porous material composite equals 0.65˜0.83.

Regarding the porous material composite, wherein the porous material is one selected from the group consisting of sheetlike inorganic clay, porous charcoal, porous metallic material and porous inorganic material.

In order to achieve at least the above objective, the present disclosure provides a method of producing a porous material composite, comprising the steps of: (a) forming a first reactant by mixing silver salts-containing precursor solution, protecting agent, and the porous material and then reaction therebetween, wherein the protecting agent stabilizes particle diameter and structure of nanosilver particles formed from the silver salts-containing precursor; (b) attaching the silver salts-containing precursor to an outer surface and an inner surface of the porous material; (c) introducing organic reductant into the first reactant to form a second reactant, wherein the silver salts-containing precursor is reduced by the organic reductant to form nanosilver particles; and (d) introducing alkalinizing agent into the second reactant.

Regarding the method, wherein the organic reductant is of a concentration of 2˜15 mM.

The nanosilver particles, the porous material composite comprising the same, and the method of producing the same together render it feasible to produce nanosilver particles which no chemical reductant lingers on and the porous material composite comprising the nanosilver particles, so as to overcome a drawback of the prior art—conventional nanosilver particles are usually produced by chemical synthesis, using chemical reductants, and products which contain conventional nanosilver particles are harmful to the human body.

### BRIEF DESCRIPTION OF THE DRAWINGS

FIG. 1 is a schematic view of the process flow of production of nanosilver particles according to an embodiment of the present disclosure.

FIG. 2 is a graph of absorptivity against particle diameter of nanosilver particles according to an embodiment of the present disclosure.

FIG. 3 is a graph of nanosilver particles absorbance against wavelength according to an embodiment of the present disclosure.

FIG. 4 is a graph of distribution of incidence angle of crystal structure of nanosilver particles according to an embodiment of the present disclosure.

FIG. 5 shows graphs of bacteriostasis of nanosilver particles according to an embodiment of the present disclosure.

FIG. 6 is a bar chart of cellular activity test result of nanosilver particles according to an embodiment of the present disclosure.

FIG. 7 is a schematic view of the process flow of production of a porous material composite according to an embodiment of the present disclosure.

FIG. 8 is a graph of bacteriostasis test result of the porous material composite according to an embodiment of the present disclosure.

FIG. 9 is a microscopic schematic view of the porous material composite according to an embodiment of the present disclosure.

FIG. 10 is energy dispersive X-ray spectroscopy (EDS) of the porous material composite in FIG. 9 according to an embodiment of the present disclosure.

FIG. 11 is a microscopic schematic view of another porous material composite according to an embodiment of the present disclosure.

FIG. 12 is energy dispersive X-ray spectroscopy (EDS) of the porous material composite in FIG. 11 according to an embodiment of the present disclosure.

FIG. 13 is a microscopic schematic view of another porous material composite according to an embodiment of the present disclosure.

FIG. 14 is energy dispersive X-ray spectroscopy (EDS) of the porous material composite in FIG. 13.

### DETAILED DESCRIPTION OF THE INVENTION

To facilitate understanding of the object, characteristics and effects of this present disclosure, embodiments together with the attached drawings for the detailed description of the present disclosure are provided.

Method of Producing Nanosilver Particles:

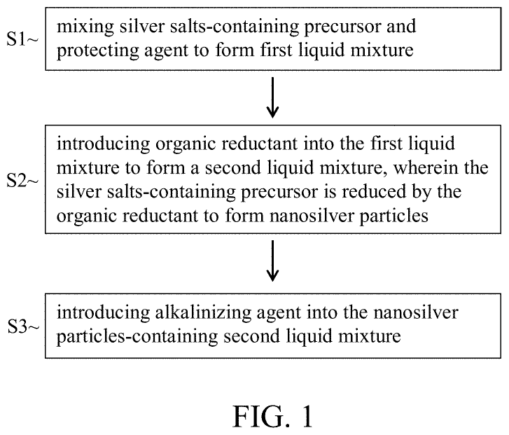

Referring to FIG. 1, in this embodiment, a method of producing nanosilver particles comprises the steps below.

Step (S1): In a photophobic environment, one ml of silver salts-containing precursor silver nitrate (AgNO₃) solution of a concentration of 4 mg/ml and one ml of polyvinylpyrrolidone (PVP) solution of a concentration of 20 mg/ml are introduced into a serum flask which contains 18 ml of pure water solution to form a first liquid mixture, and then a magnet is placed in the serum flask. The magnet rotates at 600 rpm to blend the first liquid mixture for about 10 minutes until the first liquid mixture is uniform. In step (S1), the PVP functions as the protecting agent. In this embodiment, the protecting agent stabilizes the structure of nanosilver particles and keeps the particle diameter of nanosilver particles within a specific range.

Step (S2): In a photophobic environment, one ml of gallic acid solution of a concentration of 9.375 mM is introduced into the first liquid mixture to form a second liquid mixture, and the magnet rotates at 600 rpm to blend the second liquid mixture for about 5 minutes such that silver nitrate is reduced and thus turned into nanosilver particles. In step (S2), the gallic acid functions as the organic reductant.

Step (S3): introduce 130 μl of sodium hydroxide (NaOH) of a concentration of 1 M is introduced into the second liquid mixture to change the pH of the second liquid mixture to 11, i.e., alkaline state, such that the PVP stabilizes the structure of nanosilver particles. In step (S3), the sodium hydroxide functions as an alkalinizing agent for stabilizing the structure of nanosilver particles and enhancing the dispersion of nanosilver particles.

In this embodiment, the silver salts-containing precursor used in the course of producing the nanosilver particles is silver nitrate. However, in another embodiment, silver salts-containing precursor is one selected from the group consisting of silver nitrate (AgNO₃), silver chloride (AgCl), silver oxalate (Ag₂C₂O₄), and silver acetate (AgC₂H₃O₂), or any other silver salts-containing precursor, which is not restricted to this embodiment.

In this embodiment, to prevent the decomposition of silver nitrate in the course of producing the nanosilver particles, the production of the nanosilver particles has to take place in a photophobic environment. However, in another embodiment, the decomposition of silver nitrate in the course of production is prevented by another means, which is not restricted to this embodiment.

In this embodiment, the PVP functions as the protecting agent. However, in another embodiment, the protecting agent is natural colloid or synthetic colloid, for example, the protecting agent is one selected from the group consisting of gelatin, alginate, agar, chitosan, lecithin, hyaluronic acid (HA), polyvinyl alcohol (PVA), polyacrylamide (PAM), polyethylene glycols (PEG), and polyvinylpyrrolidone (PVP), or any substance which stabilizes the structure of nanosilver particles and the particle diameter of nanosilver particles, which is not restricted to this embodiment.

W. Phae-ngam et al. (2017), “One-step green synthesis of chitosan-silver nanoparticles,” Suan Sunandha Science and Technology Journal 10.14456/ssstj.2017.3 discloses using chitosan as a protecting agent. K. Shameli et al. (2012), “Synthesis and Characterization of Polyethylene Glycol Mediated Silver Nanoparticles by the Green Method,” Int J Mol Sci. 13(6): 6639-6650 discloses using polyethylene glycol as a protecting agent.

In this embodiment, the organic reductant is gallic acid. Gallic acid inhibits the growth of bacteria, such as Staphylococcus aureus, Klebsiella pneumoniae, Acinetobacter baumannii, Pseudomonas aeruginosa, and Escherichia coli, in vitro. Furthermore, the toxicity of gallic acid has strong effect on cells which have undergone fibrosis and cancer cells and thus is effective in killing the cancer cells of patients with breast cancer, leukemia, gastric cancer and lung cancer. By contrast, the toxicity of gallic acid has weak effect on normal cells. Therefore, in this embodiment, gallic acid lingering on the surfaces of the nanosilver particles reduced by gallic acid augments bacteriostasis or bactericidal efficacy.

In another embodiment, the organic reductant is one selected from the group consisting of glucose, sucrose, maltose, starch, catechin, ascorbic acid, and gallic acid, or any substance for reducing the organic reductant of silver salts-containing precursor, which is not restricted to this embodiment.

Y. Qin et al. (2010), “Size control over spherical silver nanoparticles by ascorbic acid reduction,” Colloids and Surfaces A: Physicochem. Eng. Aspects, 372 172-176 discloses using ascorbic acid as organic reductant. Yakout S M et al. (2015), “A novel green synthesis of silver nanoparticles using soluble starch and its antibacterial activity,” Int J Clin Exp Med. 2015; 8(3): 3538-3544 discloses using starch as organic reductant.

In step (S1) of this embodiment, the concentrations of silver salts-containing precursor silver nitrate solution and PVP solution only serve an illustrative purpose. In another embodiment, the concentrations of silver salts-containing precursor silver nitrate solution and PVP solution are adjustable conditions for production, whereas the time taken to mix the first liquid mixture is also an adjustable condition for production, which are not restricted to this embodiment.

In step (S2) of this embodiment, the concentration (9.375 mM) of gallic acid can be changed to 2˜15 mM (for example, 2 mM, 2.5 mM, 3 mM, 3.5 mM, 4 mM, 4.5 mM, 5 mM, 5.5 mM, 6 mM, 6.5 mM, 7 mM, 7.5 mM, 8 mM, 8.5 mM, 9 mM, 9.375 mM, 9.5 mM, 10 mM, 10.5 mM, 11 mM, 11.5 mM, 12 mM, 12.5 mM, 13 mM, 13.5 mM, 14 mM, 14.5 mM, and 15 mM) or any other concentration range, whereas the concentration of gallic acid can be adjusted according to the volume of the gallic acid solution introduced and any other condition for production, provided that silver nitrate is reduced and thus turned into nanosilver particles. The aforesaid technical features are not restricted to this embodiment.

In step (S3) of this embodiment, the pH of the second liquid mixture is changed to 11. However, in another embodiment, the pH of the second liquid mixture ranges from 8 to 12, and thus can, for example, be pH 8, pH 8.5, pH 9, pH 9.5, pH 10, pH 10.5, pH 11, pH 11.5, pH 12 to allow the protecting agent to stabilize the structure of nanosilver particles. In step (S3) of this embodiment, the alkalinizing agent is replaced by another alkalinizing solution of potassium hydroxide, whereas the concentration and volume of the alkalinizing agent can be adjusted as needed, but is not restricted to this embodiment.

Testing Particle Diameter of Nanosilver Particles:

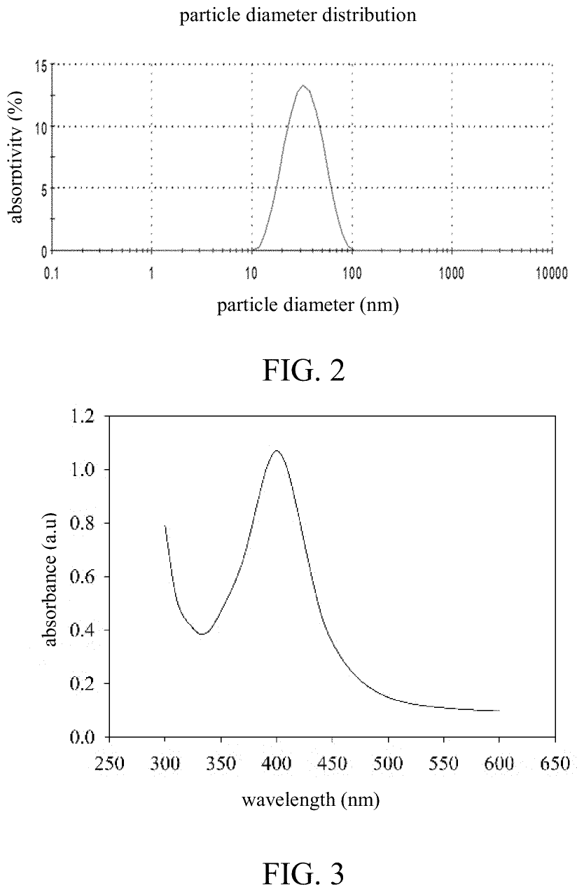

In this embodiment, the particle diameter of the nanosilver particles produced by the method of the present disclosure is tested with a particle diameter analyst. The test results are shown in FIG. 2, indicating that the particle diameter of the nanosilver particles is 10˜100 nm.

Measuring Wavelength and Absorbance of Nanosilver Particles:

In this embodiment, a full wavelength scan is performed on nanosilver particles with ELISA reader to measure wavelength and absorbance of the nanosilver particles. The measurement results are shown in FIG. 3, indicating that the nanosilver particles in this embodiment have a specific absorption spectrum at wavelength 400˜410 nm, wherein 400˜410 nm is the normal wavelength range of conventional nanosilver particles.

Analysis of Crystal Structure of Nanosilver Particles:

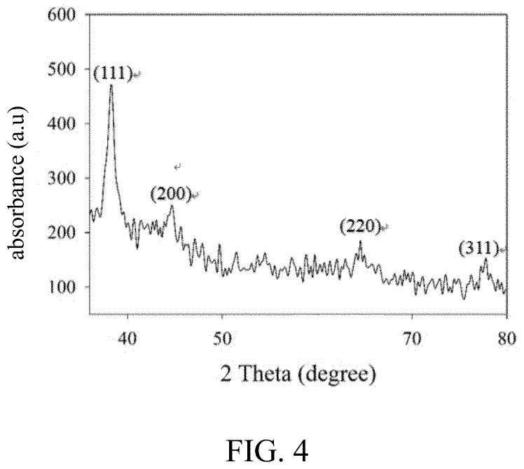

The crystal structure of the nanosilver particles in this embodiment is analyzed with X-ray diffractometer (XRD). First, a specimen for use in analysis is prepared by taking an appropriate amount of dried nanosilver particle powder and then adhering the dried nanosilver particle powder to a slide with an area of 1 cm² to form the specimen. Afterward, the specimen is placed in the XRD to measure peak distribution from 35 to 80 degrees and compare the measurements with a JCPDS (Joint Committee on Powder Diffraction Standard) card for confirming whether the displayed numerical values indicate silver (Ag), X-ray source is Cu-Kα radiation, wavelength is 0.154 nm, operating current and voltage are 200 mA and 50 kV, respectively. The test results are shown in FIG. 4 as follows: incidence angle 2 Theta of crystal structures (111), (200), (220), (311) are 38.23 degree, 44.42 degree, 64.59 degree, and 77.27 degree, respectively. The 2 Theta numerical values conform substantially with the measured 2 Theta numerical values of the crystal structures of conventional nanosilver particles.

Nanosilver Particle Bacteriostasis Test:

The efficacy of bacteriostasis of the nanosilver particles in this embodiment is tested, using Escherichia coli (E. coli). First, E. coli is grown in LB culture medium. Afterward, a single strain is selected with an inoculation rod and then inoculated in a conical flask which contains 100 ml of LB liquid culture medium. Then, the conical flask is placed in an incubator and rotated at 150 rpm at a constant temperature of 37° C. to undergo cultivation for 10 hours. Afterward, the conical flask is removed from the incubator, and then the bacterial broth is removed from the conical flask. In the end, absorbance of the bacterial broth at O.D 600 is measured with UV-Vis and found to be of a numerical value of 0.06.

Afterward, four 14 ml sterile cultivation pipes are prepared, and one ml of E. coli broth of the aforesaid control group is introduced into each cultivation pipe. One of the cultivation pipes contains only E. coli broth and is regarded as a control group. One ml of nanosilver particles solution of a concentration of 400 μg/ml (400 ppm) is introduced into each of the other three cultivation pipes to be regarded as experimental groups. All the nanosilver particles of the experimental groups are produced by the method of producing nanosilver particles in this embodiment. The difference between the nanosilver particles in the three experimental group samples lies in the concentrations of the gallic acid used in the course of producing the nanosilver particles. The concentrations of the gallic acid are 5 mM, 9.375 mM and 11 mM. The three experimental group samples are named experimental group 1, experimental group 2 and experimental group 3 according to the concentrations, 5 mM, 9.375 mM and 11 mM, of the gallic acid used in the course of producing the nanosilver particles, respectively. Afterward, experimental groups 1-3 are placed in an incubator and rotated at 150 rpm at a constant temperature of 37° C. while being cultivated for 20 hours. At four points in time, i.e., 2, 4, 6, and 20 hours after experimental groups 1-3 have been placed in the incubator, variations in absorbance of their broths are measured at O.D 600 with UV-Vis.

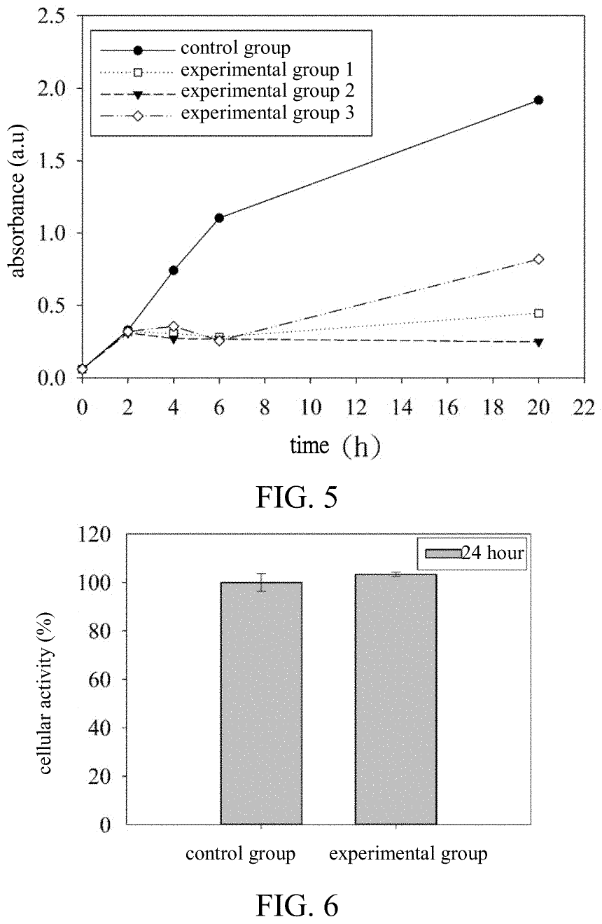

In this embodiment, test results about bacteriostasis of nanosilver particles are shown in FIG. 5 as follows: O.D 600 absorbance of the control group at the 20th hour is 1.917, whereas O.D 600 absorbance of experimental groups 1-3 at the 20th hour is 0.446, 0.249, and 0.819, respectively. This shows that the nanosilver particles produced in the presence of gallic acid demonstrate satisfactory antimicrobial efficacy, wherein the nanosilver particles produced in the presence of gallic acid of a concentration of 9.375 mM demonstrate preferred antimicrobial efficacy. Therefore, the nanosilver particles in this embodiment are antimicrobial, bactericidal, and capable of removing odor generated by microorganism. Furthermore, in general, the nanosilver particles inhibit the growth of fungi, i.e., anti-mold.

Test on Cellular Activity of Nanosilver Particles:

First, a 12-hole microplate is prepared. One ml of the cellular fluid of epidermis fibroblast NIH/3T3 (cultivated in DMEM culture medium) is introduced into three of the 12 holes of the microplate each to be regarded as the control group samples, and then one ml of NIH/3T3 cellular fluid and nanosilver particles of a concentration of 1 μg/ml (1 ppm) in this embodiment are introduced into any other three of the 12 holes of the microplate each to be regarded as experimental group samples. Afterward, the 12-hole microplate is placed in a cell incubator operating at 37° C. and filled with 5% CO₂, so as to undergo cultivation for 12 hours until cells grow to such an extent that the cells occupy 50% of the capacity of each hole (each hole contains about 0.15×10⁶ cells). After being cultivated in the cell incubator for 12 hours, the 12-hole microplate is removed from the cell incubator, and then 1.5 ml of 3-(4,5-dimethylthiazol-2-yl)-2,5-diphenyltetrazolium bromide (MTT) of a concentration of 0.5 mg/ml is introduced into the holes which contain the control group sample and experimental group samples each. The 12-hole microplate which the MTT solution has been introduced into is, again, placed in the cell incubator operating at 37° C. and filled with 5% CO₂, so as to undergo cultivation for three hours before being removed. Dimethyl sulfoxide (DMSO) (500 μl/well, 99.5%) is introduced into the holes which contain the control group sample and experimental group samples each, so as to dissolve formazan crystals generated from a cell toxicity test. Finally, ELISA reader scans the control group sample and experimental group samples to measure their absorbance at a wavelength of 560 nm so as to evaluate cellular activity.

Experimental results are shown in FIG. 6, the cellular activity of the experimental group samples can be as high as 100% or above. The test results about the cellular activity of the nanosilver particles show that application of the nanosilver particles of this embodiment to the production of bactericidal products or bacteriostatic products is not harmful to the human skin by the ordinary use of the products.

Method of Producing Porous Material Composite:

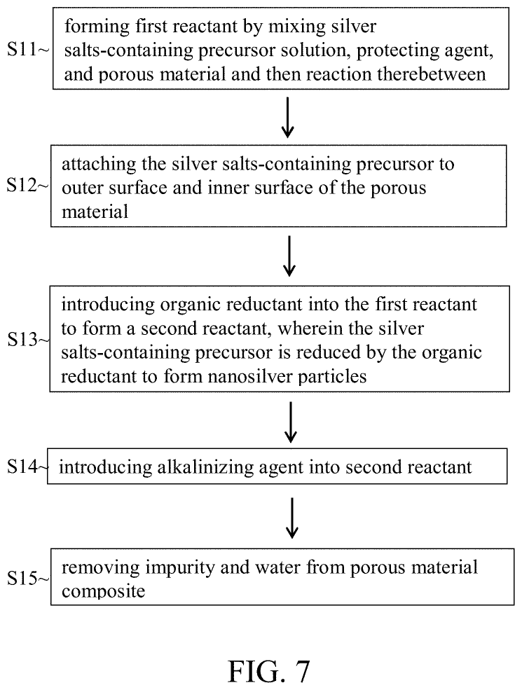

Referring to FIG. 7, in this embodiment, a method of producing a porous material composite comprises the steps below.

Step (S11): In a photophobic environment, one ml of silver salts-containing precursor silver nitrate solution of a concentration of 4 mg/ml, 0.15 g of mica with a diameter of 5 mm, and one ml of PVP solution of a concentration of 20 mg/ml are introduced into a serum flask which contains 18 ml of pure water solution to jointly form a first reactant. Furthermore, a magnet is placed in the serum flask and rotated at 600 rpm to blend the silver nitrate solution, mica and PVP solution for about 10 minutes, thereby ensuring sufficient reaction therebetween. In step (S11), the PVP is a protecting agent, whereas the mica is a porous material serving as a carrier for the porous material composite in step (S11).

Step (S12): in a photophobic environment at a constant temperature of 25° C., the mica is quietly immersed in the liquid mixture of the silver nitrate solution and PVP solution for 60 minutes such that the silver nitrate is attached to the outer surface of the mica and the bored inner surface of the mica.

Step (S13): In a photophobic environment, one ml of gallic acid solution of a concentration of 9.375 mM is introduced into the first reactant to form a second reactant, and the magnet rotates at 600 rpm to blend it for about 5 minutes, such that silver nitrate is reduced by the gallic acid and thus turned into nanosilver particles. In step (S13), the gallic acid solution functions as the organic reductant.

Step (S14): 130 μl of sodium hydroxide of a concentration of 1 M is introduced into the second reactant, and the magnet rotates at 800 rpm to blend it, so as to change the pH of the second reactant to 11, i.e., alkaline state, such that not only does the PVP stabilize the structure of nanosilver particles, but the nanosilver particles are also attached to the outer surface of the mica and the bored inner surface of the mica. Therefore, the present disclosure enables a porous material composite comprising nanosilver particles to be produced. The way to form the nanosilver particles included in the porous material composite in this embodiment is the same as the way to form the nanosilver particles by the aforesaid method of producing nanosilver particles. Therefore, the porous material composite in this embodiment is also antimicrobial, bactericidal, anti-mold, and deodorizing. In step (S14), the sodium hydroxide functions as the alkalinizing agent for stabilizing the structure of the nanosilver particles.

Step (S15): the porous material composite produced in step (S14) is placed in 50 ml of water and heated to 60° C., and then the hot water stays at 60° C. for 10 minutes to remove impurity. Then, the porous material composite is taken out of the water and put in an oven in which the porous material composite is dried at 70° C. to remove water therefrom. Afterward, the porous material composite is heated for one hour before being removed and cooled. The purpose of step S15 is to render the porous material composite ready for processing rather than produce the porous material composite; hence, step S15 is optional.

The aforesaid method of producing nanosilver particles serves as a reference for making adjustments to all the experimental materials and experimental criteria for use in the aforesaid method of producing a porous material composite and the formation of nanosilver particles.

The porous material for use in the method of producing the porous material composite is mica. However, in another embodiment, the porous material is one selected from the group consisting of sheetlike inorganic clay, porous charcoal, porous metallic material and porous inorganic material. The sheetlike inorganic clay is ceramic, montmorillonite, mica, kaolinite, soapstone, attapulgite, or layered double hydroxide (LDH). The porous charcoal is coconut shell activated carbon, bamboo charcoal, charcoal, or bincho charcoal. The porous inorganic material is diatomaceous earth or algae. The porous metallic material is titanium; however, the porous material can be any porous material, provided that nanosilver particles are attached to it, and thus it is not restricted to this embodiment.

Analysis of Surface Area of Porous Material Composite:

In this embodiment, the ratio of an attachment area of the porous material's outer and inner surfaces which the nanosilver particles are attached to the surface area of the porous material composite is measured by micromeritics ASAP 2020 and according to the surface area.

The principle of micromeritics ASAP 2020 and surface area is: owing to adsorption of gas to solid (a solid sample under test is referred to as the “adsorbent”, and gas molecules are referred to as the “adsorbate”), under a specific pressure, reversible, physical adsorption of the adsorbate to the surface of the adsorbent occurs at low temperature. As soon as the adsorption reaches equilibrium, its balanced adsorption pressure and gas adsorption level are measured, and the resultant measurements are used to calculate the surface area of the sample according to the Brunauer-Emment-Teller (BET) equation.

In this experiment, first, a ceramic ball (made of a ceramic material, i.e., a porous material) which is 0.25 g in weight and 7 mm in diameter is prepared so as to function as a control group sample under test, and then the control group sample is put in a test tube. Furthermore, degassing is carried out inside the test tube. The test tube is heated at a temperature-raising speed of 10° C./min until it reaches 300° C.; then, the test tube stays at 300° C. for 12 hours such that both water and adsorbed impurity is removed from the control group sample to reduce errors. Afterward, the test tube is moved to an analysis station. The analysis process entails immersing the test tube in liquid nitrogen and filling the test tube with a fixed amount of gaseous nitrogen to analyze the gaseous nitrogen adsorption level under different relative pressures. The analysis result is used to calculate the surface area of the control group sample by the Brunauer-Emment-Teller (BET) technique.

Afterward, a porous material composite comprising nano silver ions is produced from the ceramic ball by the method of producing the porous material composite such that the porous material composite comprising nano silver ions functions as an experimental group sample under test. The experimental group sample under test is used to obtain the surface area of the experimental group sample according to a test method of the control group sample.

The surface area of the control group sample is about 2.5˜3 m²/g, and the surface area of the experimental group sample is about 1.2˜2 m²/g. Therefore, the ratio of an attachment area of the porous material's outer and inner surfaces which the nanosilver particles are attached to the surface area of the porous material composite is calculated by an equation as follows: surface area of control group sample—surface area of experimental group sample/surface area of experimental group sample. According to the equation, the ratio equals 0.65˜0.83 approximately. Therefore, the ratio of an attachment area of the porous material's outer and inner surfaces which the nanosilver particles are attached to the surface area of the porous material composite produced by the method of producing the porous material composite in this embodiment is about 0.65˜0.83. Although the aforesaid surface area analysis test entails using a ceramic ball as a porous material test sample, the ratio of an attachment area of the porous material's outer and inner surfaces which the nanosilver particles are attached to the surface area of the porous material composite produced by the method of producing the porous material composite from mica and another porous material in this embodiment is about 0.65˜0.83.

Test on Adsorption of Material to Porous Material Composite:

In this embodiment, substances adsorbable to the porous material composite and the adsorption level are detected by ICP-OES.

First, five ceramic balls each 0.25 g in weight and 7 mm in diameter are used to produce the porous material composite comprising nano silver ions in this embodiment by the porous material composite production method provided in the porous material composite surface area analysis method. Afterward, five solutions which contain lead (Pb), copper (Cu), mercury (Hg), cadmium (Cd), and arsenic (As), respectively, are prepared. The metallic solutions are each 50 ml in volume. The concentration of the metals in the metallic solutions is 0.1 μg/ml (100 ppb). The five porous material composites comprising nano silver ions in this embodiment are immersed in the five metallic solutions, respectively, and stay still for 30 minutes. At this moment, the concentrations of the metallic solutions which the porous material composites are immersed in decrease to 70˜90 ppb. The above experimental result shows that 10˜30 ppb of substances which contain lead, copper, mercury, cadmium or arsenic are adsorbable to the porous material composite comprising nano silver ions and produced from the ceramic ball.

The concentrations of the metallic solutions are calculated and analyzed with ICP-OES (Perkin Elmer; Optima 7000 DV). The process of analyzing the concentrations of the metallic solutions with ICP-OES is as follows: the solutions under test are atomized with an atomization system or atomizer and converted into an aerosol; then, the atomized solutions (aerosol) are delivered to the ICP-OES such that fine particles of the aerosol are carried by argon gas to the annular center of plasma, whereas large particles of the aerosol are expelled; the aerosol which has entered the plasma undergoes, at high temperature, evaporation, drying, decomposition, atomization and ionization. Atoms and ions, which are generated in the course of the atomization and ionization, are excited and emit electromagnetic waves at different specific wavelengths; finally, the electromagnetic waves with different specific wavelengths pass through an optical system and thus fall on a detector to therefore generate and send an electrical signal to a computer. The computer compares the electrical signal with standard electrical signal and thus calculates the concentrations of the solutions.

Porous Material Composite Bacteriostasis Efficacy Test:

First, E. coli is grown in LB culture medium. Afterward, a single strain is selected with an inoculation rod and then inoculated in a conical flask which contains 30 ml of LB liquid culture medium. Then, the conical flask is placed in an incubator and rotated at 150 rpm at a constant temperature of 37° C. to undergo cultivation for 10 hours. Afterward, the conical flask is removed from the incubator, and then E. coli broth is removed from the conical flask. The absorbance of the E. coli broth at O.D 600 is measured with UV-Vis and found to be of a numerical value of 0.65. Afterward, 200 μl of the E. coli broth is taken out of the conical flask which contains the 30 ml LB liquid culture medium and uniformly coated on solid-state agar. Then, mica 0.15 g in weight and 5 mm in diameter is used to produce porous material composite A (100 ppm of nanosilver particles produced by the production method in this embodiment are attached to the surface of the porous material composite A) according to the porous material composite production method in this embodiment, and then the porous material composite A is placed on the solid-state agar coated with the E. coli broth to function as a sample under test. After the sample under test has been placed in the incubator and cultivated at 37° C. for 18 hours, bacterial growth within a bacteriostasis zone diameter (zone of inhibition) surrounding the sample under test is observed and the bacteriostasis zone diameter is measured. The larger the inhibition zone diameter is, the higher the bacteriostasis efficacy is.

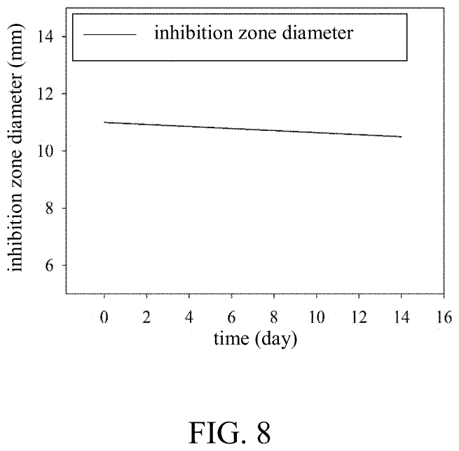

The test results are shown in FIG. 8. At the end of 18 hours' cultivation (day 0 in FIG. 8), the inhibition zone diameter is found to be 11 mm. At the end of 14 days' cultivation, the inhibition zone diameter is found to be 10.5 mm. This indicates that the efficacy of bacteriostasis of the porous material composite in this embodiment is high and persistent.

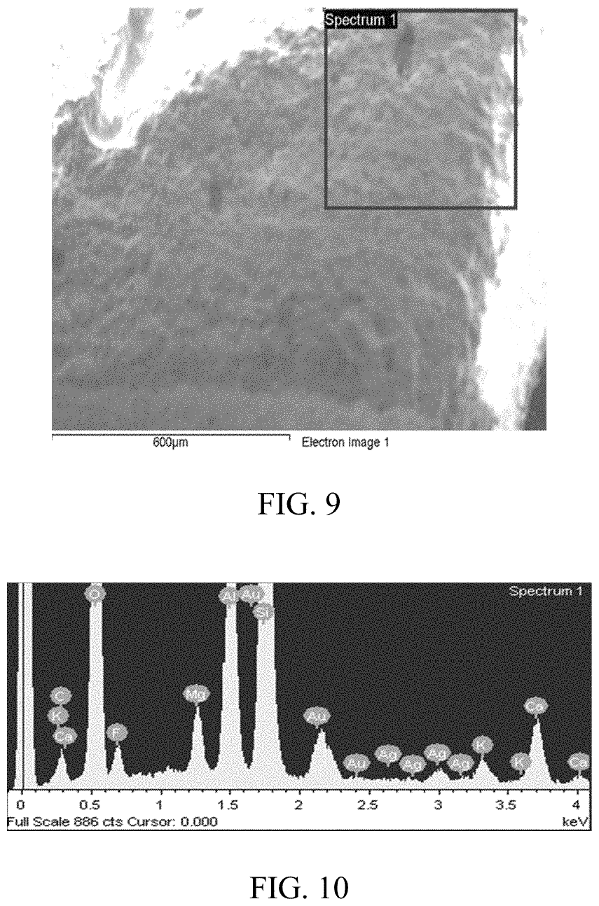

FIG. 9 shows the porous material composite produced from mica by the porous material composite production method according to this embodiment and observed under an electron microscope. FIG. 10 shows energy dispersive X-ray spectroscopy (EDS) of the porous material composite in FIG. 9. As shown in FIG. 10, an element signal of silver (Ag) is generated at 3 keV, confirming the presence of nanosilver particles in the porous material composite in FIG. 10.

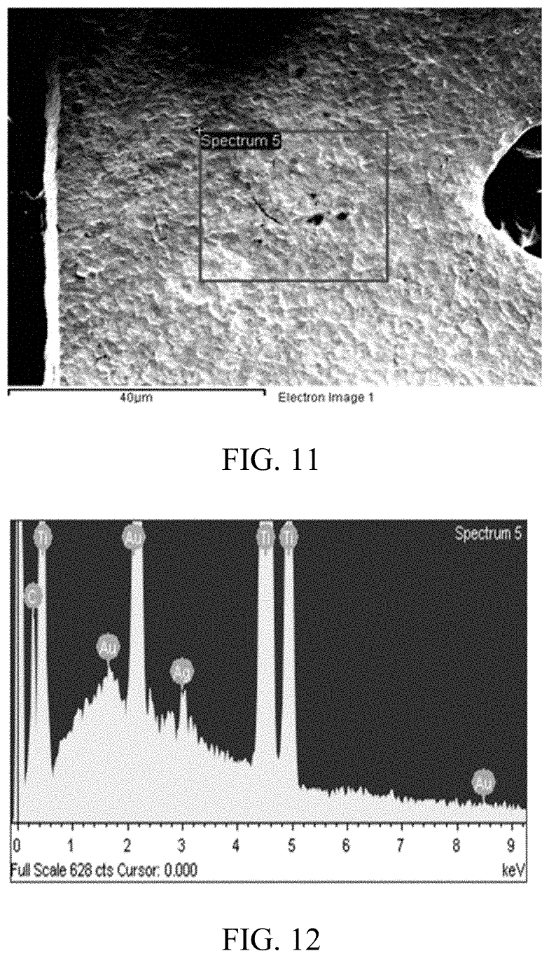

FIG. 11 shows the porous material composite produced from titanium material by the porous material composite production method in this embodiment and observed under an electron microscope. FIG. 12 shows energy dispersive X-ray spectroscopy (EDS) of the porous material composite in FIG. 11. As shown in FIG. 12, an element signal of silver is generated at 3 keV, confirming the presence of nanosilver particles in the porous material composite in FIG. 11.

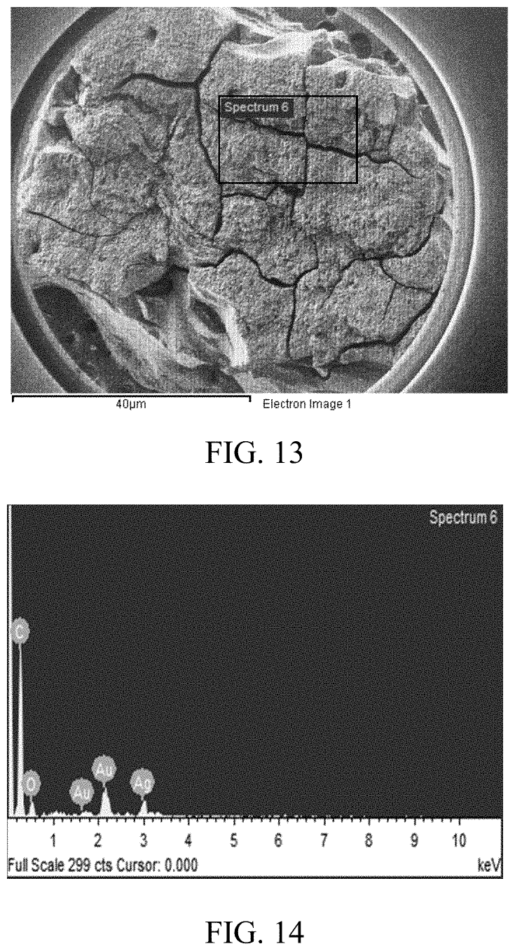

FIG. 13 shows the porous material composite produced from porous carbon material by the porous material composite production method in this embodiment and observed under an electron microscope. FIG. 14 shows energy dispersive X-ray spectroscopy (EDS) of the porous material composite in FIG. 13. As shown in FIG. 14, an element signal of silver is generated at 3 keV, confirming the presence of nanosilver particles in the porous material composite in FIG. 13.

Various products, for example, filtering materials, are produced from the nanosilver particles and porous material composite in this embodiment and are free of residues of chemical substances. Furthermore, the products can be recycled and reused to meet requirement of environmental protection.

The nanosilver particles and porous material composite comprising the nanosilver particles, which are free of residues of chemical reductants, are produced by a process which involves performing reduction by a natural reductant. This overcomes a drawback of the prior art, that is, conventional nanosilver particles are produced by chemical synthesis, and in consequence products which contain the conventional nanosilver particles pose a risk to users' health. In this embodiment, nanosilver particles are reduced by gallic acid, and gallic acid on the surfaces of the nanosilver particles further enhances bacteriostasis or bactericidal efficacy.

While the present disclosure has been described by means of specific embodiments, numerous modifications and variations could be made thereto by those skilled in the art without departing from the scope and spirit of the present disclosure set forth in the claims.

What is claimed is:

1. A method of producing nanosilver particles, comprising the steps of:
(a) mixing silver salts-containing precursor and protecting agent to form a first liquid mixture, wherein the protecting agent stabilizes particle diameter and structure of nanosilver particles formed from the silver salts-containing precursor;
(b) introducing organic reductant into the first liquid mixture to form a second liquid mixture, wherein the silver salts-containing precursor is reduced by the organic reductant to form nanosilver particles; and
(c) introducing alkalinizing agent into the nanosilver particles-containing second liquid mixture.

2. The method of claim 1, wherein the second liquid mixture has a pH of 8-12.

3. The method of claim 1, wherein the silver salts-containing precursor is one selected from the group consisting of silver nitrate, silver chloride, silver oxalate, and silver acetate.

4. The method of claim 1, wherein the organic reductant is one selected from the group consisting of glucose, sucrose, maltose, starch, catechin, ascorbic acid, and gallic acid.

5. The method of claim 1, wherein the organic reductant is of a concentration of 2˜15 mM.

6. Nanosilver particles produced by the method of claim 1.

7. Nanosilver particles produced by the method of claim 2.

8. Nanosilver particles produced by the method of claim 3.

9. Nanosilver particles produced by the method of claim 4.

10. Nanosilver particles produced by the method of claim 5.

11. A porous material composite, comprising:
a porous material; and
nanosilver particles attached to an outer surface and an inner surface of the porous material,
wherein a ratio of an attachment area of the outer and inner surfaces which the nanosilver particles are attached to a surface area of the porous material composite equals 0.65˜0.83.

12. The porous material composite of claim 11, wherein the porous material is one selected from the group consisting of sheetlike inorganic clay, porous charcoal, porous metallic material, and porous inorganic material.

13. A method of producing a porous material composite, comprising the steps of:
(a) forming a first reactant by mixing silver salts-containing precursor solution, protecting agent, and the porous material and then reaction therebetween, wherein the protecting agent stabilizes particle diameter and structure of nanosilver particles formed from the silver salts-containing precursor;
(b) attaching the silver salts-containing precursor to an outer surface and an inner surface of the porous material;
(c) introducing organic reductant into the first reactant to form a second reactant, wherein the silver salts-containing precursor is reduced by the organic reductant to form nanosilver particles; and
(d) introducing alkalinizing agent into the second reactant.

14. The method of claim 13, wherein the organic reductant is of a concentration of 2˜15 mM.
